(19) United States
(12) Patent Application Publication
(10) Pub. No.: US 2021/0073718 A1
(43) Pub. Date: Mar. 11, 2021

(54) Marina Inventory Management System

(71) Applicant: Leon Maksin, Brooklyn, NY (US)

(72) Inventor: Leon Maksin, Brooklyn, NY (US)

(21) Appl. No.: 16/565,712

(22) Filed: Sep. 10, 2019

(51) Int. Cl. G06Q 10/08; G06T 11/60

(52) U.S. Cl. CPC G06Q 10/087; G06K 9/00671; G06T 2215/16; G06T 11/60

(57) ABSTRACT

A system for managing marina inventory that can visually and meaningfully presents the current inventory of a marina and that can allow a user to rapidly and easily make changes to inventory status. A computer interconnected to a display is programmed to visually produce a map of the slips of the marina and allow for textual information and background colors to be selectively applied to each slip of the marina. The background colors may be selected to indicate a lease status for each of the plurality of slips and to indicate whether a boat is present in any of the slips.

### BACKGROUND OF THE INVENTION

### 1. Field of the Invention

The present invention relates to marina inventory management and, more specifically, to a system for providing a visual rendering of the status of the inventory of a marina.

### 2. Description of the Related Art

Marinas generally comprise one of more piers, each of which has one or more boat slips that can be individually leased by a user on a temporary or recurring basis. In order to manage existing inventory, a marina operator must keep track of the status of each slip with respect to both the status of customer leases and whether there is currently a boat in the slip. The conventional approach for managing this information involves the use of whiteboards, blackboards, or the like, on which the operator manually writes (and erases) the status information for each slip. Accordingly, there is a need in the art for a system that can track all of the information needed by a marina operator while presenting the information in a readily apparent manner.

### BRIEF SUMMARY OF THE INVENTION

The present invention is a system for managing marina inventory that can visually and meaningfully present the existing inventory of a marina and allow a user to rapidly and easily make changes to the inventory status. The system comprises a display and a computer interconnected to the display. The computer is programmed to cause the display to visually present a first set of fixed content and a first set of variable content. The first set of fixed content comprises a rendering of a physical layout of a marina to be managed. The first set of variable content comprises a plurality of textual fields and a plurality of background fields. The physical layout of the marina includes a plurality of slips. Each of the plurality of slips includes a corresponding one of the plurality of textual fields and a corresponding one of the plurality of background fields. The corresponding background field for each of the plurality of slips comprises a single one of a plurality of colors, each of which may be selected to indicate a lease status for each of the plurality of slips. Each of the plurality of slips includes a second background field. The second background field for each of the plurality of slips comprises a single one of a second plurality of colors, each of which may be selected to indicate whether a boat is present in a corresponding one of the plurality of slips. The lease status is selected from the group consisting of leased, lease pending, vacant, and temporary use.

The present invention also includes a method of managing marina inventory that can visually and meaningfully present the existing inventory of a marina and allow a user to rapidly and easily make changes to the inventory status. The method comprises the step of providing a display and a computer interconnected to the display, wherein the computer is programmed to cause the display to visually present a first set of fixed content and a first set of variable content, wherein the first set of fixed content comprises a rendering of a physical layout of a marina to be managed and the variable content comprises a plurality of textual fields and a plurality of background fields. The method further comprises the step of changing the plurality of textual fields and the plurality of background fields to reflect a status of the marina inventory. The method may further comprise the step of selecting a single one of a plurality of colors for the background field of each of the plurality of slips to indicate a lease status for each of the plurality of slips. The method may additionally comprise the step of selecting a single one of a second plurality of colors for the second background field for each of the plurality of slips to indicate whether a boat is present in a corresponding one of the plurality of slips.

### BRIEF DESCRIPTION OF THE SEVERAL VIEWS OF THE DRAWING(S)

The present invention will be more fully understood and appreciated by reading the following Detailed Description in conjunction with the accompanying drawings, in which:

FIG. 1 is a schematic of a marina showing the inventory status according to the present invention;

FIG. 2 is a schematic showing a selected number of slips in the marina and the inventory status for those slips according to the present invention;

FIG. 3 is a chart of exemplary color coding for use with a display according to present invention; and

FIG. 4 is a schematic of another embodiment of the present invention.

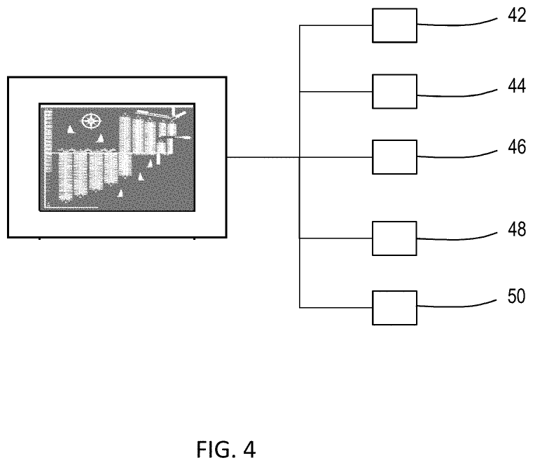

### DETAILED DESCRIPTION OF THE INVENTION

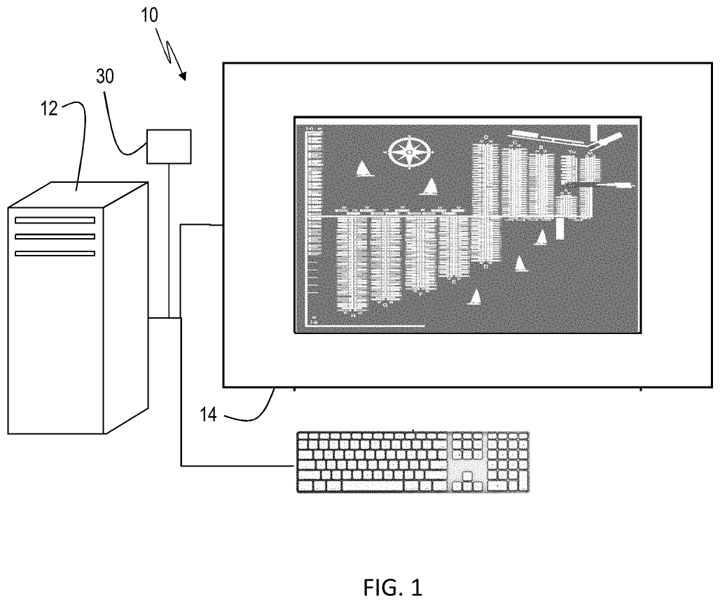

Referring to the figures, wherein like numeral refer to like parts throughout, there is seen in FIG. 1 a system 10 for managing a marina. System 10 comprises a physical computer 12 and a display 14, such as an LCD monitor, interconnected and driven by the computer 12. Computer 12 includes a user input device, such as a keyboard, or could additionally or alternatively use touch screen capabilities of display 14 for user input. Computer 12 could also comprise a dedicated processor with embedded firmware in lieu of a programmed general purpose computer or server device. Interconnection between computer 12 and display 14 is shown as a wired connection, such as an HDMI® or USB connection, but could comprise a conventional wireless connection, such as WiFi (802.11x) network or Bluetooth® short-wavelength UHF connection. Display 14 includes static content 16 and variable content 18. Static content 16 preferably comprises a rendering of the marina with individual piers 22 and slips 24 illustrated to correspond to a particular marina. It should be recognized that if system 10 is designed for use with multiple marinas, static content 16 would changeable to selectively display a rendering for each marina to be managed according to the present invention. The present invention therefore comprises, among other things, an improved graphical user interface specifically for marina inventory management systems. More specifically, the present invention provides a visible rendering and presentation of certain summarized information along with selected static and dynamic information for a significant improvement in inventory management and relative ease of use. By restricting the type of information and location of the restricted types of information, the present invention provides an improved user interface for a specific electronic device, namely, a marina inventory management system having computer 12 and associated display 14. Use of the present invention improves the efficiency of using system 10 by bringing together a limited list of common functions and commonly accessed stored data so such items can be accessed from a single main menu that is also a rendering of the marina itself.

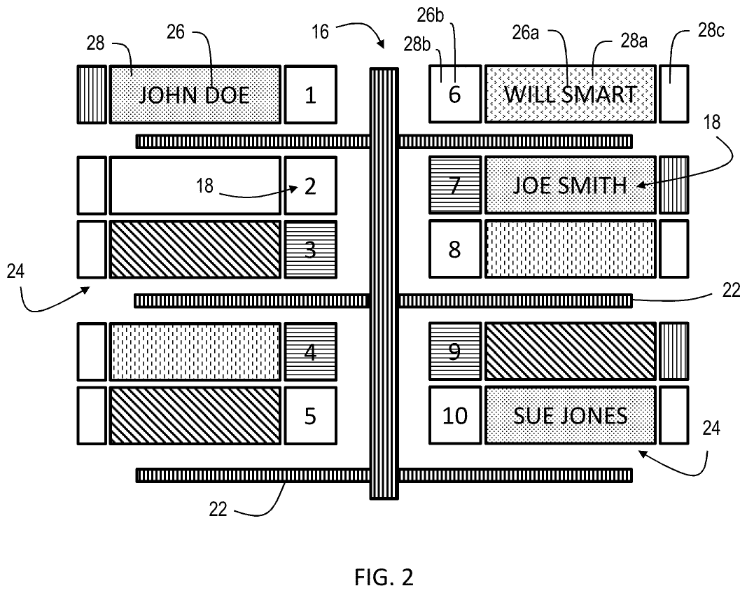

Referring to FIG. 2, variable content 20 comprises at least one text entry field 26 associated with each slip 24 and one background field 28 associated with each slip 24. In the example of FIG. 2, variable content 20 includes a first text entry field 26a where lessee names may be entered (or any other desired information) and a second text entry field 26b containing a number assigned to the particular slip. It should be recognized that the particular textual information in text entry field 26 may be selected by the user of system 10 according to the particular needs of the marina being managed according to the present invention.

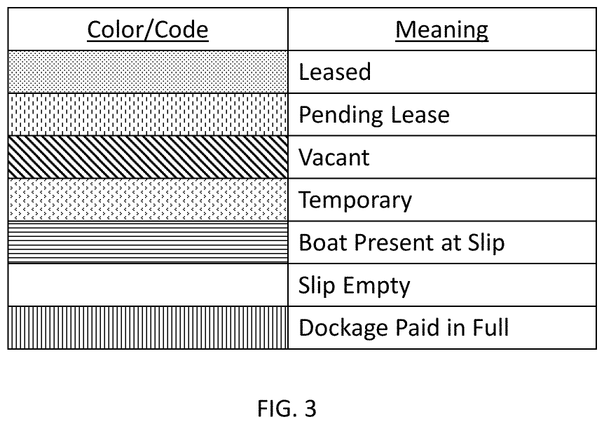

As further seen in FIG. 2, variable content 20 in the exemplary illustration also includes a first background field 28a surrounding text entry field 26a, a second background field 28b surrounding text entry field 26b, and a third background field 28c that is not associated with a corresponding text entry field 26. Background field 28 is designed to be selectable between a plurality of representations that reflect information pertaining to each slip 24. For example, as seen in FIG. 3, specific colors (represented by conventional graphic drawing symbols) may be used as status indicia that are coded to specific meanings, such as whether a given slip 24 is leased, the subject of a pending lease, vacant, or under temporary use. The status indicia may also be coded to represent the physical status of slip 24, i.e., whether a boat is present or whether the slip is empty. Thus, first background field 28a may be used to represent lease status, second background field 28b used to represent whether a boat is present, and third background field 28c used to represent whether a boater has paid the appropriate dockage fee in full. It should be recognized that additional background fields 28 could be included to reflect any other status information desired by the user of system 10. While textures or patterns may certainly be used, a color coded view is preferred as it provides the fastest recognition of the represented content. Similarly, icons may be used to reflect status information, such as a boat symbol for the presence of a boat or a document icon to signify that a lease is in place.

Computer 12 may thus be programmed to allow a user to edit the textual information in text entry field 26 and select the appropriate color for background field 28 (or otherwise toggle the representation between colors, symbols, icons, etc.). For example, colors for background field 28 may be limited to specific colors, with the user allowed to toggle between the colors using a user input device, such as keyboard. Similarly, the keyboard may be used to enter text into text entry field 26. It should be recognized that touch screen devices may instead be employed, where a user could simply touch text entry field 26 and enter text with a virtual keyboard or press a particular background field 28 to toggle between available colors until the appropriate color has been selected.

System 10 may further include sensors 30 for automatically providing information for assessment and rendering on display 14. For example, motion sensors or the like may be used to identify a boat occupying slip 24 and thus triggering a change in second background field 28b. Similarly, system 10 may be integrated with a payment management system to automatically color code third background field 28c to indicate that dockage fees are outstanding or paid. One or more digital cameras may also be interconnected to system 10 for identifying the presence of boats, detecting changes in status for automatic rendering on display 14, or for providing a basic image for use as static content 16. Static content 16 could also be generated from aerial photograph or satellite photos for more realistic rendering of a particular marina or marinas. Image processing may further be used to extract information about a boat located in slip 24, such as registration information or boat name, with text entry field 26 automatically populated from the extract information.

System 10 may additional be used for improving payment collection processes. For example, a change in status of second background field 28b can be exported to a marina accounting system 42 to cause the generation of an invoice for docking fees or stored over time in a database forming part of computer 12 to establish a usage history in the event that a user contests any dockage charges or whether leasing fees are due. Preferably, each change entered into system 10 is tracked over time to ensure compliance with any regulatory requirements and establish a record for tax and legal purposes. As is known in the art, computer 12 may be programmed to generate reports 44 of any and all activity at the marina as represented by changes made to variable content 18 over time.

In another aspect, computer 12 could drive display 14 to render static content 16 and variable content 18 alongside, or in overlay mode, with respect to a real-time view the associated marina. In this way, a user could instantly appreciate from viewing display 14 whether the data presented on display 14 was accurate, or whether there had been a change in circumstance that required attention dockside. For example, the arrival of a boat in a given slip 24 could trigger an alert from a speaker 46 that a marina representative should proceed to that slip 24 for collection of fees, etc. A detected change by system 10 could also trigger a circuit breaker 48 or other electrical system controller to allow dockside power to be made available to a newly arrived boat, or disconnected when a boat departs slip 24 to ensure that any power lines are not left untended and powered. Thus, system 10 could be used to track and record power usage for a billing system 50 or to confirm power was made available and used to a boat owner.

As described above, the present invention may be a system, a method, and/or a computer program associated therewith and is described herein with reference to flowcharts and block diagrams of methods and systems. The flowchart and block diagrams illustrate the architecture, functionality, and operation of possible implementations of systems, methods, and computer programs of the present invention. It should be understood that each block of the flowcharts and block diagrams can be implemented by computer readable program instructions in software, firmware, or dedicated analog or digital circuits. These computer readable program instructions may be implemented on the processor of a general purpose computer, a special purpose computer, or other programmable data processing apparatus to produce a machine that implements a part or all of any of the blocks in the flowcharts and block diagrams. Each block in the flowchart or block diagrams may represent a module, segment, or portion of instructions, which comprises one or more executable instructions for implementing the specified logical functions. It should also be noted that each block of the block diagrams and flowchart illustrations, or combinations of blocks in the block diagrams and flowcharts, can be implemented by special purpose hardware-based systems that perform the specified functions or acts or carry out combinations of special purpose hardware and computer instructions.

What is claimed is:

1. A system for managing marina inventory, comprising:
a display; and
a computer interconnected to the display and programmed to cause the display to visually present a first set of fixed content and a first set of variable content, wherein the first set of fixed content comprises a rendering of a physical layout of a marina to be managed and the first set of variable content comprises a plurality of textual fields and a plurality of background fields.

2. The system of claim 1, wherein the physical layout of the marina includes a plurality of slips.

3. The system of claim 2, wherein each of the plurality of slips includes a corresponding one of plurality of textual fields and a corresponding one of the plurality of background fields.

4. The system of claim 3, wherein the each of the plurality of background fields is associated with each of the plurality of slips and comprises a single one of a plurality of colors, each of which may be selected to indicate a lease status for each of the plurality of slips.

5. The system of claim 4, wherein each of the plurality of slips includes a second background field.

6. The system of claim 5, wherein the second background field for each of the plurality of slips comprises a single one of a second plurality of colors, each of which may be selected to indicate whether a boat is present in a corresponding one of the plurality of slips.

7. The system of claim 5, wherein the lease status is selected from the group consisting of leased, lease pending, vacant, and temporary use.

8. A method of managing marina inventory, comprising the steps of:
providing a display and a computer interconnected to the display, wherein the computer is programmed to cause the display to visually present a first set of fixed content and a first set of variable content, wherein the first set of fixed content comprises a rendering of a physical layout of a marina to be managed and the first set of variable content comprises a plurality of textual fields and a plurality of background fields; and
changing the plurality of textual fields and the plurality of background fields to reflect a status of the marina inventory.

9. The method of claim 8, wherein the physical layout of the marina includes a plurality of slips.

10. The method of claim 9, wherein each of the plurality of slips includes a corresponding one of plurality of textual fields and a corresponding one of the background fields.

11. The method of claim 10, further comprising the step of selecting a single one of a plurality of colors for the background field of each of the plurality of slips to indicate a lease status for each of the plurality of slips.

12. The method of claim 11, wherein each of the plurality of slips includes a second background field.

13. The method of claim 12, further comprising the step of selecting a single one of a second plurality of colors for the second background field for each of the plurality of slips to indicate whether a boat is present in a corresponding one of the plurality of slips.

14. The method of claim 13, wherein the lease status is selected from the group consisting of leased, lease pending, vacant, and temporary use.
